(19) United States
(12) Patent Application Publication
(10) Pub. No.: US 2006/0155602 A1
(43) Pub. Date: Jul. 13, 2006

(54) Method of promoting fans participating in an event

(76) Inventor: Jared Durbin, Jackson, MO (US)

Correspondence Address: JAMES RAY & ASSOCIATES, 2640 PITCAIRN ROAD, MONROEVILLE, PA, 15146, US

(21) Appl. No.: 11/332,123

(22) Filed: Jan. 12, 2006

Related U.S. Application Data
(60) Provisional application No. 60/643,541, filed on Jan. 13, 2005.

(51) Int. Cl. G06Q 30/00

(52) U.S. Cl. 705/14

(57) ABSTRACT

A method of at least one of promoting, displaying, advertising and expressing interests of fans participating in an event. The method includes enabling each fan to register as a user of a web site for such at least one promoting, displaying, advertising and expressing interests of fans participating in an event. Providing access to each registered user to submit at least one entry associated with such event and storing the at least one entry in an image repository and then enabling the each registered user to view, by way of Internet, a plurality of entries stored in the image repository.

### CROSS-REFERENCE TO RELATED APPLICATIONS

This application is related to and claims priory from Provisional Patent Application Ser. No. 60/643,541 filed Jan. 13, 2005.

### FIELD OF THE INVENTION

The present invention relates, in general, to a method of promoting fans participating in an event and, more particularly, the instant invention relates to a method of promoting fans participating in a sporting event.

### BACKGROUND OF THE INVENTION

As is generally well known, many fans attending various events express their support and enthusiasm for a particular event by way of wearing special apparel, body and face painting, participating in tailgating parties, and purchasing event related memorabilia. It is further common for such fans to take pictures or, produce amateur videos, of themselves other fans or game related activities that communicate and display such support and enthusiasm.

However, the methods described above provide limited opportunity for fans interacting with others who share the same interests. Furthermore, some fans, making an extra effort to show their support and enthusiasm, would like to receive a wider recognition from other fans or the event organizers.

Therefore, there is a need for a method of promoting, displaying, advertising and expressing interests of fans participating in an event.

### SUMMARY OF THE INVENTION

According to a first embodiment of the invention, there is provided a method of at least one of promoting, displaying, advertising and expressing interests of fans participating in an event. The method includes enabling each fan to register as a user of a web site for such at least one promoting, displaying, advertising and expressing interests of fans participating in an event. The method further includes providing access to each registered user to submit at least one entry associated with such event. Next, the method provides for storing the at least one entry in an image repository. Additionally, the method includes enabling each registered user to view, by way of the Internet, a plurality of entries stored in the image repository.

According to a second embodiment, the present invention provides a method of providing a game show for at least one of promoting, displaying, advertising and expressing interests of fans participating in an event. This method includes the step of selecting at least two fans. The next step provides for enabling the at least two fans to compete between themselves in at least one predetermined activity associated with such event according to predetermined rules. The additional step includes selecting a winner based on one of the predetermined rules, voting and a combination thereof.

### OBJECTS OF THE INVENTION

It is, therefore, one of the primary objects of the present invention to provide a method of promoting fans participating in an event.

Another object of the present invention is to provide a method of promoting fans participating in an event which enable such fans to submit an entry associated with a particular event for viewing by others.

Yet another object of the present invention is to provide a method of promoting fans participating in an event which enable fans to select at least one most popular entry.

A further object of the present invention is to provide a method of promoting fans participating in an event which enable a plurality of entries to be organized into a product suitable for mass distribution.

Yet a further object of the present invention is to provide a method of promoting fans participating in an event which enable fans to compete among themselves.

In addition to the several objects and advantages of the present invention which have been described with some degree of specificity above, various other objects and advantages of the invention will become more readily apparent to those persons who are skilled in the relevant art, particularly, when such description is taken in conjunction with the appended claims.

### BRIEF DESCRIPTION OF THE VARIOUS EMBODIMENTS OF THE INVENTION

According to a first embodiment of the invention, there is provided a method of at least one of promoting, displaying, advertising and expressing interests of fans participating in an event. The event may be categorized as one of a sport, race, concert, musical, television show, convention, exhibition, public gathering, tailgating, artist, and acting. The entry is selected from the group consisting of a picture, digital picture file, video and print.

The method includes providing means to such fans for submitting a plurality of entries associated with such event. Such plurality of entries may be submitted by way of conventional mail delivery service. It is presently preferred that such plurality of entries are uploaded, as images, by way of the Internet web site. In order to achieve such upload, each fan desiring to upload the image must first register on the web site by completing an online form. The fan is prompted to establish unique user name and password in order to authenticate such fan during future uses of the website and provide a predetermined personal information for contact purposes. The fan may also be prompted to select at least one category of the referred event the user desires to participate in. The fan may be further prompted to provide a payment by way of the Internet in order to complete registration. When the registration is completed, the fan that is now one of the users of the web site can upload one or more images. At the time of upload, the user may be required to provide additional payment by way of the Internet. It will be appreciated that entries submitted by way of the conventional mail delivery service may be first converted, if required, into a digital format suitable for upload into the web site. This will be advantageous in situations when the submitted entry is a regular picture, a non-digital video tape or a print. The fan submitting the entry by way of conventional mail must register in order to have such entry accepted.

Another step in the process involves storing the plurality of submitted entries in an image repository, which is preferably formed by a predetermined plurality of sub-image repositories, each associated with a unique category of such event. Accordingly, each submitted entry is selectively stored in at least one of the plurality of sub-image repositories.

The additional step in the process includes enabling the registered users of the web site to view, by way of Internet, the plurality of entries stored in the image repository. Advantageously, to improve efficiency of viewing, each user may select a sub-image repository of a particular interest and view only the entries contained in such sub-image repository.

The method may include the step of enabling registered users to vote, by Internet, on at least one entry stored in either the entire image repository or in a particular sub-image repository. Furthermore, at least one entry, voted on by the users, may be selected based on a quantity of votes received over a predetermined period of time. Next, the fan that submitted an entry receiving a predetermined quantity of votes, preferably the highest, may be rewarded by way of a monetary or non-monetary award. Additionally, a picture of such fan and the submitted entry may be prominently displayed on the web site. Alternatively, a predetermined plurality of the entries may be selected based on the quantity of received votes in either ascending or descending order.

The method may further include selecting and organizing at least a portion of the plurality of submitted entries into a product suitable for mass distribution. Such product may be one of a plurality of cards suitable for one of trading and collecting, print media, compact disk, digital video disk, video tape, TV show, contest, and film. Such product is advantageous for use in at least one of promoting, displaying, advertising and expressing interests and support of fans to others, including the event members.

It will be understood that a TV show provides an effective way of promoting and advertising interest and support of fans to a large audience of viewers both fans and non-fans of a particular event. The method may further include enabling such audience to vote by way of Internet, phone, being present in a TV studio and various combinations thereof for at least one entry chosen among the at least a portion of the plurality of entries.

Alternatively, activities of at least one fan may be filmed at the actual location of the event and incorporated into such TV show.

The TV show may be broadcast weekly, monthly or at any other predetermined frequency.

By way of example, fans of a football team go to great lengths in wearing team related apparel or accessories, painting body parts with indicia reflective of the team name and, most of all, verbally supporting the team during the game. They also invest significant effort to stage elaborate tailgating parties, decorate vehicles with team colors and logos and the like to display their enthusiasm and support. The TV show further provides an opportunity for football team members to witness the lifestyle and devotion of their most loyal supporters outside of the game environment where their focus is on the game itself.

According to a second embodiment, the present invention provides a method of providing a game show for at least one of promoting, displaying, advertising and expressing interests of fans participating in an event. This method includes the step of selecting at least two fans. Such at least two fans may be randomly selected from participants of a live audience present at such game show, randomly selected from owners of entries placed into image repository or based on the quantity of votes received by a respective images within the image repository.

The method further includes the step of enabling the at least two fans to compete between themselves in at least one predetermined activity associated with such event in accordance with predetermined rules of the competition and additionally includes the step of selecting a winner based on one of the predetermined rules, voting and combination thereof.

The game show may take place, at a predetermined frequency, in front of the live audience and be broadcasted in live or taped fashion. The voting may be achieved by one of live studio audience, remotely disposed viewers and a combination thereof.

Alternatively, competing fans may be videotaped at an actual location of such event and the videotaped material is broadcasted and distributed by way of TV network or Internet.

Next, the winner may be rewarded by way of a monetary or non-monetary award.

The game show may also be associated with at least one sponsor who contributes to such reward and who is additionally promoted during the game show.

It will be appreciated that at least two groups, each consisting of a predetermined plurality of fans may be selected for competition.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A method of at least one of promoting, displaying, advertising and expressing interests of fans participating in an event, said method comprising the steps of:
(a) enabling each fan to register as a user of a web site for such at least one of promoting, displaying, advertising and expressing interests of fans participating in an event;
(b) providing access to each registered user to submit at least one entry associated with such event;
(c) storing said at least one entry in an image repository; and
(d) enabling said each registered user to view, by way of Internet, a plurality of entries stored in said image repository.

2. The method, according to claim 1, wherein said entry is one of a picture, digital picture file, video and print.

3. The method, according to claim 1, wherein a category of such event is one of a sport, race, concert, musical, television show, convention, exhibition, public gathering, tailgating, artist, and acting.

4. The method, according to claim 1, wherein said image repository includes a predetermined plurality of sub-image repositories each associated with a unique category of such event.

5. The method, according to claim 4, wherein each entry submitted in step (b) is selectively stored in at least one of said plurality of sub-image repositories.

6. The method, according to claim 1, wherein said method further includes the step of enabling each registered user to vote, by way of Internet, on at least one entry stored in said image repository.

7. The method, according to claim 6, wherein said method further includes the step of selecting at least one entry based on a quantity of votes received over a predetermined period of time.

8. The method, according to claim 7, wherein said method further includes the step of rewarding a fan that submitted an entry receiving a predetermined quantity of votes.

9. The method, according to claim 1, wherein said method further includes the step of selecting and organizing at least a portion of said plurality of entries submitted in step (b) into a product suitable for mass distribution.

10. The method, according to claim 9, wherein said product is one of a plurality of cards suitable for one of trading and collecting, print media, compact disk, digital video disk, video, TV show, contest, and film.

11. The method, according to claim 9, wherein said method further includes the step of using said product for one of promoting and advertising such fans.

12. The method, according to claim 9, wherein said product is said TV show and said method further includes the step of enabling viewers of said TV show to vote by way of one of Internet, being present in a TV studio and a combination thereof for at least one entry chosen among said at least portion of said plurality of entries.

13. The method, according to claim 1, wherein said each fan provides, during registration, at least a user name and password for authentication during subsequent access to said web site.

14. The method, according to claim 1, wherein each entry is submitted by way of one of conventional mail delivery service and Internet.

15. A method for providing a game show for at least one of promoting, displaying, advertising and expressing interests of fans participating in an event, said method comprising the steps of:
(a) selecting at least two fans;
(b) enabling said at least two fans to compete between themselves in at least one predetermined activity associated with such event according to predetermined rules; and
(c) selecting a winner based on one of said predetermined rules, voting and a combination thereof.

16. The method, according to claim 15, wherein competition between said at least two fans takes place in one of a studio and actual location of such event.

17. The method, according to claim 15, wherein said game show is broadcast at a predetermined frequency.
